(19) United States
(12) Patent Application Publication
(10) Pub. No.: US 2006/0212483 A1
(43) Pub. Date: Sep. 21, 2006

(54) Apparatus and method of downloading content related to an optical disc

(75) Inventor: Sung-ryeul Rhyu, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/377,193

(22) Filed: Mar. 17, 2006

(30) Foreign Application Priority Data
Mar. 17, 2005 (KR) 2005-22189

(51) Int. Cl. G06F 7/00

(52) U.S. Cl. 707/104.1

(57) ABSTRACT

A method and apparatus for downloading content related to an optical disc, via a network, are provided. According to the method and apparatus, when an optical disc needs to be replaced, while download is proceeding, the identification (ID) information of the disc replaced is separately stored in a memory such that, even though the disc is replaced, the downloading of the content related to a previous disc can be continued and at the same time the content of a new disc can be smoothly reproduced. Accordingly, even though the disc is replaced while downloading content, via the network, downloading of such content continues and content of the new disc is reproduced smoothly.

### CROSS-REFERENCE TO RELATED APPLICATIONS

This application claims all benefits accruing under 35 U.S.C. §119 from Korean Patent Application No. 10-2005-0022189, filed on Mar. 17, 2005, in the Korean Intellectual Property Office, the disclosure of which is incorporated by reference herein.

### BACKGROUND OF THE INVENTION

1. Field of the Invention

The present invention relates to an apparatus and method of reproducing multimedia contents, and more particularly, to a method and apparatus for downloading content related to an optical disc, via a network.

2. Related Art

Recently, a content reproducing apparatus has been developed and equipped with a network function and a local storage such that content data (typically, a multimedia content, e.g., audio visual data) related to a storage medium, such as an optical disc can be downloaded, via a web server specified by a content provider. The downloaded content related information is then stored in the local storage disposed at the content reproducing apparatus. As a result, content related information recorded on the disc can be updated or new content related information that has not been recorded on the disc can be added thereon. A Java application is typically used to download the content related to the disc, via a network such as the Internet.

FIG. 1 illustrates typical execution states of applications when discs are replaced while the applications are being executed. Referring to FIG. 1, if a disc is replaced while an application is being executed, the disc identification (ID) information is also updated. Accordingly, an ordinary application that does not require disc ID information can be designed by selection of the author of the application, so that, when a disc is replaced in the middle of the execution of the application, the execution of the application can be completed or finished (as indicated by reference #1), or extended (continue the execution) until the downloading of the contents related to the disc is completed (as indicated by reference #2). However, for an application that requires disc ID information, when a disc is replaced in the middle of the execution of the application, the execution of the application should be completed or finished (as indicated by reference #3) since the disc ID information is updated. As a result, the execution of the application (as indicated by reference #4) is impossible.

Meanwhile, a Java application for downloading a content related to a disc, via a network, requires a disc ID in order to protect an illegal copying of such content from an unauthorized user. Therefore, if a disc, for example, disc A is ejected, while downloading of content is proceeding, as shown in FIG. 1, the disc ID becomes invalid such that the downloading cannot be continued and is abnormally terminated. As a result, while downloading of content is proceeding, it is not possible to replace an existing disc with a new disc having content desired to be enjoyed by a user.

In addition, the conventional downloading method does not provide a function in which, while downloading of content is proceeding, content of a new disc can also be reproduced. As a result, when downloading of content is proceeding, and if other content is desired to be reproduced, a user has to wait until the downloading is completed or finished for a few minutes, or tens of minutes depending on the condition of the network, such as the Internet.

### SUMMARY OF THE INVENTION

Various aspects and example embodiments of the present invention provide a method and apparatus for smoothly downloading contents related to a storage medium such as an optical disc, even though the disc is replaced while downloading such a content, via a network, and also provide a download method and apparatus capable of reproducing a title recorded on a newly replaced disc, or executing another application, while downloading such a content, via the network.

Additional aspects and/or advantages of the invention will be set forth in part in the description which follows and, in part, will be obvious from the description, or may be learned by practice of the invention.

In accordance with an embodiment of the present invention, a method of downloading and reproducing content related to an optical disc, comprises: beginning downloading of a content file related to the disc to be updated or added through a network; and if a request from a user to remove the disc is received while downloading, separately storing an identification (ID) of the disc to be removed, and continuing the downloading, wherein the disc ID is not updated until the downloading is completed, regardless of whether a new disc is inserted.

According to an aspect of the present invention, the method may further include updating the disc ID with an ID of a currently inserted disc if the downloading is completed. In particular, the separately storing of the identification (ID) of the disc to be removed, and the continuing of the downloading may further include, if a new disc is inserted during the downloading, reproducing a title recorded on the new disc according to a request from the user, while continuing the downloading.

According to an aspect of the present invention, the reproducing of the title recorded on the new disc according to a request from the user, while continuing the downloading, may further include, if a request from the user to cancel the downloading is received while the title is reproduced with continuing the downloading, invalidating the separately stored disc ID.

According to another aspect of the present invention, the separately storing of the identification (ID) of the disc to be removed, and the continuing of the downloading may further include, if a new disc is inserted during the downloading, executing an application recorded on the new disc by using the separately stored disc ID according to a request from the user, while continuing the downloading.

According to an aspect of the present invention, the execution of the application recorded on the new disc using the separately stored disk ID, may further include, if a request from the user to cancel the downloading is received while the application is executed with continuing the downloading, invalidating the separately stored disc ID.

In accordance with another embodiment of the present invention, a reproducing method of downloading and reproducing contents related to a disc, comprises: if a request from a user to remove the disc is received while downloading a content file related to the disc, via a network, is proceeding, separately storing the ID of the disc to be removed and continuing the downloading; and if the downloading is completed, updating the disc ID with an ID of a currently inserted disc, wherein the disc ID is maintained without change until the downloading is completed, even though a new disc is inserted.

According to an aspect of the present invention, the separate storing of the ID of the disc to be removed and the continuing of the downloading may further include, if a new disc is inserted during the downloading, proceeding the downloading and at the same time, according to a request from the user, reproducing a title or application recorded on the new disc. The application may be executed by using the separately stored disc ID.

According to another aspect of the present invention, the separate storing of the ID of the disc to be removed and the continuing of the downloading may further include, if a request by the user to cancel the downloading is received while the title or application is reproduced during the downloading, invalidating the separately stored disc ID.

In accordance with yet another embodiment of the present invention, an apparatus for downloading and reproducing content related to a disc, comprises: a local storage manager arranged to download a content file related to the disc to be updated or added through a network; and an application manager arranged to store, if a request from a user to remove the disc is received while downloading proceeds, an identification (ID) of the disc to be removed, and continue the downloading, wherein the disc ID is not updated until the downloading is completed, regardless of whether or not a new disc is inserted.

In accordance with another embodiment of the present invention, a reproducing apparatus for downloading and reproducing content related to a disc, comprises: a first manager arranged to control the download of a content file related to the disc through a network; and a second manager arranged to store, if a request from a user to remove the disc is received while the downloading is proceeding, an ID of the disc to be removed and, if the downloading is completed, update the disc ID with an ID of a currently inserted disc, wherein the second manager maintains the disc ID without change until the downloading is completed, even though a new disc is inserted, and wherein the first manager continues the downloading by using the disc ID, regardless of whether or not the disc is removed.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates typical execution states of applications when discs are replaced while the applications are being executed;

FIG. 2 is a block diagram of an example reproducing apparatus which downloads contents related to a disc according to an embodiment of the present invention; and

FIGS. 3A and 3B are a flowchart illustrating a method of downloading contents related to a disc according to an embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the present invention, when a disc needs to be replaced while download is proceeding, the identification (ID) information of the disc replaced is separately stored in a memory such that, even though the disc is replaced, the downloading of content related to the previous disc can be continued and at the same time the content of a new disc can be smoothly reproduced.

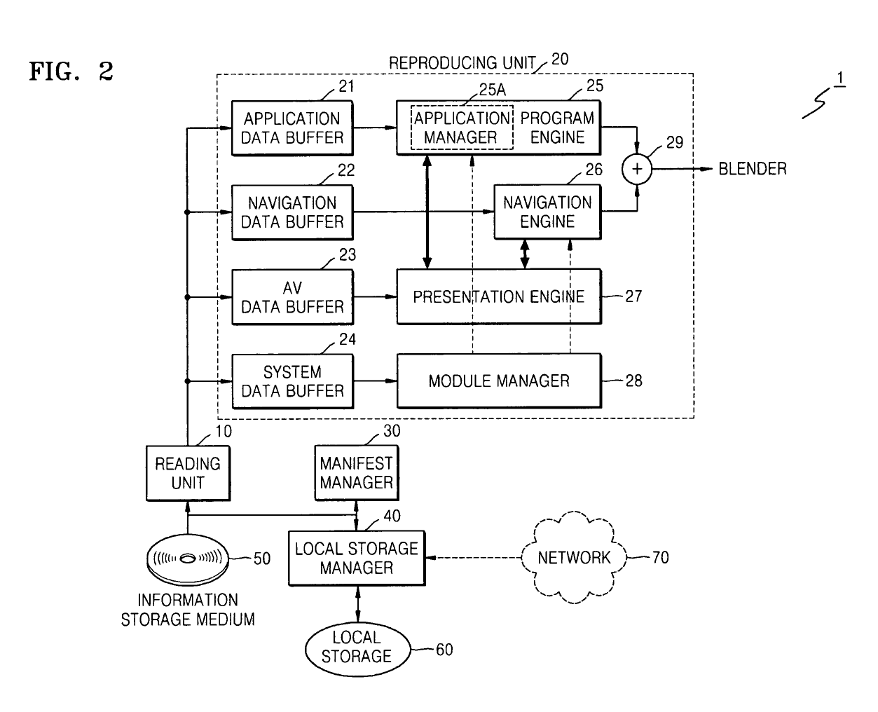

FIG. 2 is a block diagram of an example reproducing apparatus which downloads contents related to a disc according to an embodiment of the present invention. Referring to FIG. 2, the reproducing apparatus 1 includes a reading unit 10, a reproducing unit 20, a manifest manager 30, a local storage manager 40, which manages the download of content from an external web server, via a network 70, into a local storage 60 and the incorporation of downloaded content into content recorded on an optical disc 50 serving as an information storage medium.

The reading unit 10 reads a content file, i.e., audio-visual (AV) data, from an optical disc 50, such as a Blu-ray disc (BD) or a DVD, or a local storage 60 such as a hard disc, and a flash memory. In particular, the content file stored in the local storage 60 represents multimedia data downloaded from a web server provided by a content provider, via a network 70.

The reproducing unit 20 receives the content file (AV data) from the reading unit 10, and decodes and reproduces the content file. In particular, the reproducing unit 20 includes different types of buffers, such as an application data buffer 21, a navigation data buffer 22, an AV data buffer 23, a system data buffer 24, to store different types of content reproduced from the optical disc 50, and corresponding engines, such as a program engine 25, a navigation engine 26, and a presentation engine 27 to drive different types of content reproduced from the optical disc 50 for content reproduction. In addition, an application manager 25A may be included in the program engine 25 to manage different types of program mode data reproduced from the optical disc 50. A module manager 28 may also be included to control content recorded on the optical disc 50 to be reproduced together with content downloaded, via a network 70.

Other items such as a search unit and a user interface are not shown, but can be incorporated to enable a user, via a user interface, to search for one or more scenes from the content recorded on the optical disc 50 or the content downloaded, via the network 70, that match a search keyword and to provide a visual display of search results.

The local storage manager 40 downloads a content file related to the optical disc 50, via a network 70, stores the content file in a local storage 60, and manages content files stored in the local storage 60. In addition, the manifest file manager 30 combines a content file read from an optical disc 50 with downloaded content files stored in a local storage 60 to generate virtual titles, and by managing the virtual titles, controls the reproducing unit 20 so that the reproducing unit 20 can smoothly reproduce the downloaded content and the content recorded on the optical disc 50 together.

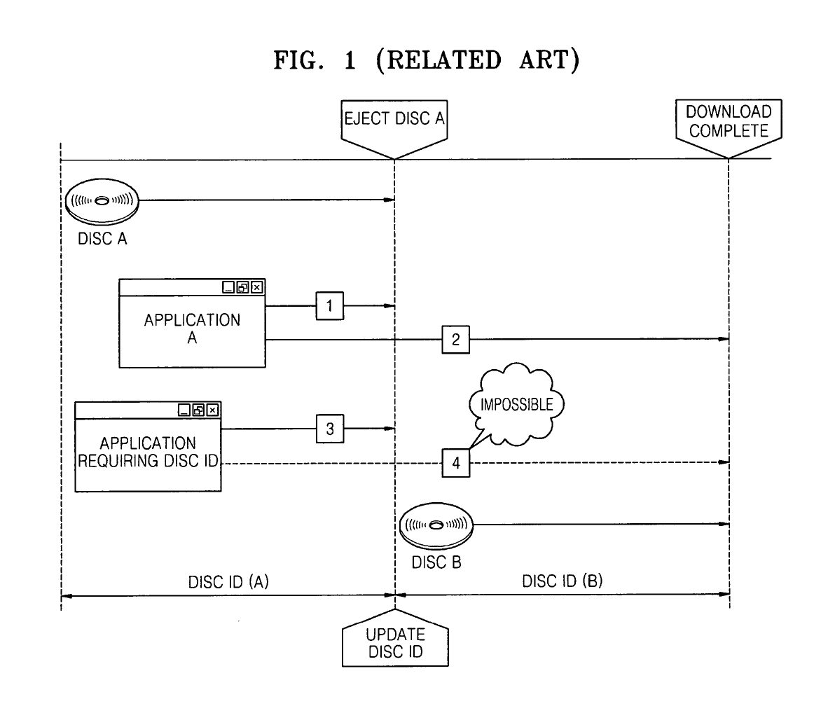

Meanwhile, the application manager 25A included in the program engine 25 of the reproducing unit 20 controls execution of a Java application, including an application for downloading content, via the network 70. In particular, if a request to remove an optical disc 50 from a user is received, while download is proceeding, the application manager 25A of the program engine 25 controls so that the ID of the disc 50 to be removed is stored in a memory (not shown) separately and the downloading can proceed continuously. At this time, the disc ID is maintained without being updated until the download is finished, regardless of whether or not a new disc is inserted. This is the characteristic of the present invention that is distinguished from the conventional download technique in which if a disc is replaced, the disc ID is immediately updated as described in connection with FIG. 1.

Also, if the download is finished, the application manager 25A of the program engine 25 updates the disc ID with an ID of the disc 50 currently placed. Furthermore, if a new disc 50 is inserted while download is proceeding, i.e., content related to the disc 50 is being downloaded, via a network 70, into the local storage 60, the application manager 25A of the program engine 25 controls reproduction of a title recorded on the new disc 50 or execution of a new application while proceeding the downloading of content related to the disc 50, via the network 70, according to a request from the user. At this time, in order to execute an application requiring a disc ID, the disc ID separately stored is used. Also, if a request by the user to cancel the downloading is received, while a new title is reproduced or a new application is executed with the downloading proceeding, the application manager 25A of the program engine 25 invalidates the separately stored disc ID.

In short, if the user requests to eject a disc 50, while downloading is proceeding, the reproducing apparatus 1, as shown in FIG. 2, stores an ID of the disc 50 to be removed separately in a memory (not shown). The stored ID information of the disc 50 may be maintained in a separate memory without change until the application for download is finished. That is, before the downloading is finished, the disc ID is not updated in the memory regardless a new disc is inserted. If an application recorded on a newly inserted disc 50 requests a disc ID, the reproducing apparatus 1 utilizes the disc ID of a previous disc separately recorded. Also, if the application for download is finished, the disc ID is immediately invalidated.

Accordingly, even though a disc 50 is replaced while download is proceeding, the download can be continuously proceeding. Also, while download is proceeding, a title recorded on a newly inserted disc 50 can be reproduced, or an application on the disc 50 can be executed.

A method of downloading content related to an optical disc, via a network, according to an embodiment of the present invention based on the structure of the reproducing apparatus as shown in FIG. 2 will now be explained herein below.

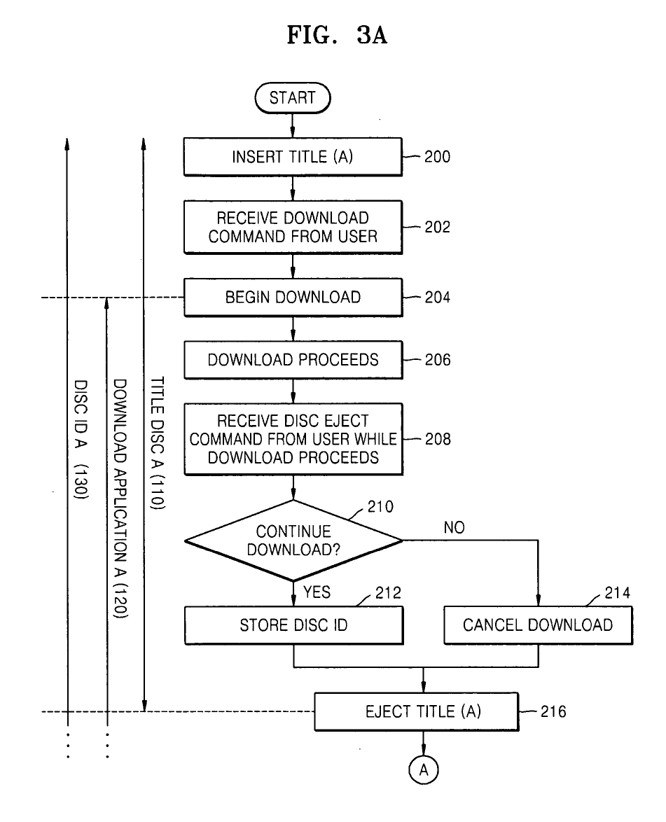

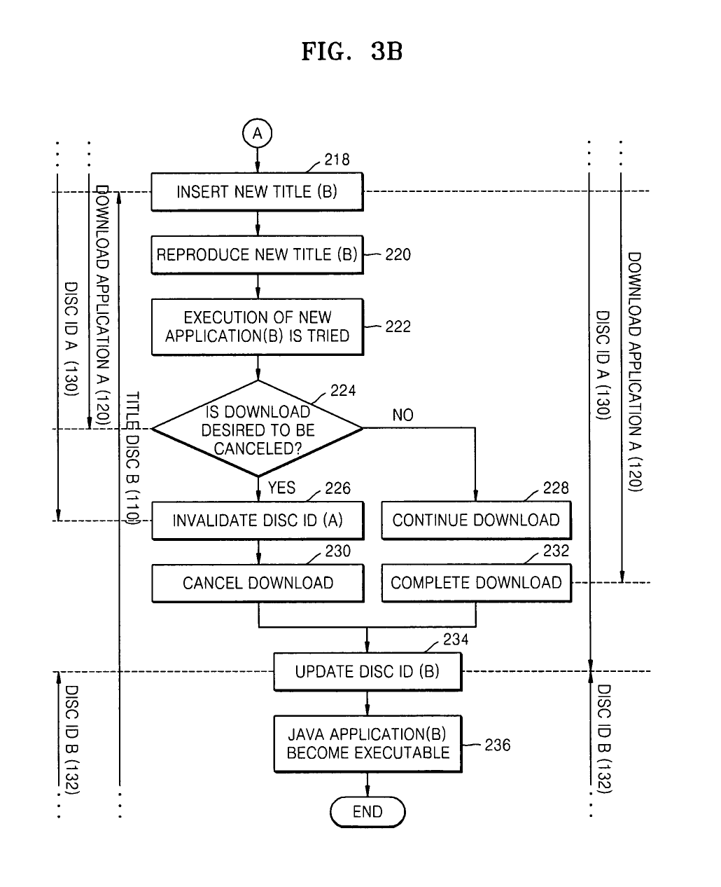

FIGS. 3A and 3B are a flowchart illustrating a method of downloading content related to an optical disc according to an embodiment of the present invention.

Referring to FIGS. 3A and 3B, a title disc (A) is inserted in a reproducing apparatus 1, as shown in FIG. 2, in operation 200, and a download command from a user is received in operation 202. By executing an application for download, downloading of content related to the disc (A), via a network 70, begins in operation 204. Such a content may represent audio-visual (AV) data which contains video, audio and/or subtitles, and may be compression-encoded according to known standards for digital and audio compression, such as MPEG (Motion Picture Experts Group) standard, and other types of additional information which specify encoding characteristics of the AV data, or an order in which the AV data is reproduced or even a menu of different AV data streams. Examples of such a content downloaded, via the network 70 may include a trailer introducing a new movie, or a commentary regarding a film director or an actor.

While downloading is proceeding in operation 206, if a command from the user to remove the disc (A) is received in operation 208, the reproducing apparatus 1 determines, via a user interface, such as a menu, whether or not to continue the downloading even when the disc (A) is removed in operation 210. If the user wants to continue the downloading in operation 212, an ID of the disc (A) to be removed is separately stored in a memory (not shown) so that the downloading can be continued even when the disc (A) is removed in operation 212. However, if the user does not want to continue downloading, the downloading is canceled in operation 214. When the downloading is canceled, the separately stored disc ID is invalidated and the AV data being downloaded is deleted or treated appropriately.

Next, the title disc (A) is ejected in operation 216, and a new title disc (B) is inserted in operation 218. At this time, if the user wants to continue the downloading in operation 210, the title recorded on the new title disc (B) can be reproduced while the downloading is proceeding in operation 220. When the title is reproduced, the disc ID is not needed. This is because the application manager 25A of the program engine 25 controlling the execution of the application, described above, refers to the disc ID, while the navigation engine 26, as shown in FIG. 2, reproducing a title does not refer to the disc ID.

Also, execution of a new application recorded on the new title disc (B) can be tried in operation 222. If the new application does not need a disc ID, the new application can be executed. However, if the new application requires a disc ID, it can be executed by using the separately stored ID of the disc (A). At this time, whether or not to execute the new application by using the separately stored disc (A) ID may vary depending on the design of an application author.

Meanwhile, while the title is reproduced or the application is executed while proceeding with the downloading, if a request from the user to cancel the downloading is received, the separately stored disc ID is invalidated in operation 226 and the downloading is canceled in operation 230. However, if the user wants to continue the downloading, the separately stored ID of the previous disc (A) is maintained without change until the downloading is completed in operation 228.

If the downloading is canceled in operation 230 or completed in operation 232, the disc ID is updated with the ID of the currently inserted disc (B) in operation 234. Then, an application which requires a disc ID among applications recorded on the currently inserted disc (B) also becomes executable in operation 236.

Meanwhile, the method of downloading content related to an optical disc according to an embodiment of the present invention described above can be implemented as a computer readable program. Codes and code segments forming the program can be easily derived by computer programmers in the technology field of the present invention. Also, the program is stored in computer readable media, and executed in a computer, a method of downloading content related to an optical disc, via a network, is performed. The computer readable medium may be any medium, such as a magnetic recording medium, an optical recording medium, and a carrier wave medium. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable medium can also be distributed over network coupled computer systems so that the computer readable code is stored and executed in a distributed fashion.

As described above, the present invention provides a method and apparatus for smoothly downloading content related to an optical disc, via a network, even though the disc is replaced while downloading is proceeding. Accordingly, when an optical disc needs to be replaced while download is proceeding, the identification (ID) information of the disc replaced is separately stored in a memory such that, even though the disc is replaced, the downloading of the content related to the previous disc can be continued and at the same time the content of a new disc can be smoothly reproduced.

While this invention has been particularly shown and described with reference to exemplary embodiments thereof, it will be understood by those skilled in the art that various changes in form and details may be made therein without departing from the spirit and scope of the invention. For example, an optical disc may include a blu-ray disc (BD) or an advance optical disc (AOD); however, other types of an optical disc may be utilized, including, for example, DVD and CD. In addition, a reproducing apparatus as shown in FIG. 2 can be implemented as part of a recording apparatus, or alternatively a single apparatus for performing recording and/or reproducing functions with respect to a storage medium. Such a reproducing apparatus may be a single apparatus, or may be incorporated into a recording/reproducing apparatus. Likewise, the CPU can be implemented as a chipset having firmware, or alternatively, a general or special purposed computer programmed to perform the methods as described, for example, with reference to FIGS. 3A-3B. Accordingly, it is intended, therefore, that the present invention not be limited to the various example embodiments disclosed, but that the present invention includes all embodiments falling within the scope of the appended claims.

What is claimed is:

1. A method of downloading and reproducing content related to a disc, the method comprising:
beginning downloading a content file related to the disc to be updated or added, via a network; and
if a request from a user to remove the disc is received while downloading, separately storing an identification (ID) of the disc to be removed, and continuing the downloading,
wherein the disc ID is not updated until the downloading is completed, regardless of whether a new disc is inserted.

2. The method as claimed in claim 1, further comprising updating the disc ID with an ID of a currently inserted disc, if the downloading is completed.

3. The method as claimed in claim 1, wherein the separately storing of the identification (ID) of the disc to be removed, and the continuing of the downloading further comprise, if a new disc is inserted during the downloading, reproducing a title recorded on the new disc according to a request from the user, while continuing the downloading.

4. The method as claimed in claim 3, wherein the reproducing of the title recorded on the new disc according to a request from the user, while continuing the downloading, further comprises, if a request from the user to cancel the downloading is received while the title is reproduced during the downloading, invalidating the separately stored disc ID.

5. The method as claimed in claim 1, wherein the separately storing of the identification (ID) of the disc to be removed, and the continuing of the downloading further comprise, if a new disc is inserted during the downloading, executing an application recorded on the new disc by using the separately stored disc ID according to a request from the user, while continuing the downloading.

6. The method as claimed in claim 5, wherein the executing of the application recorded on the new disc using the separately stored disk ID further comprises, if a request from the user to cancel the downloading is received while the application is executed with continuing the downloading, invalidating the separately stored disc ID.

7. A reproducing method of downloading and reproducing content related to a disc, comprising:
if a request from a user to remove the disc is received while downloading a content file related to the disc, via a network, is proceeding, separately storing the ID of the disc to be removed and continuing the downloading; and
if the downloading is completed, updating the disc ID with an ID of a currently inserted disc,
wherein the disc ID is maintained without change until the downloading is completed, even though a new disc is inserted.

8. The method as claimed in claim 7, wherein the separate storing of the ID of the disc to be removed and the continuing of the downloading further comprise, if a new disc is inserted during the downloading, proceeding the downloading and at the same time, according to a request from the user, reproducing a title or application recorded on the new disc.

9. The method as claimed in claim 8, wherein the application is executed by using the separately stored disc ID.

10. The method as claimed in claim 8, wherein the separate storing of the ID of the disc to be removed and the continuing of the downloading further comprise, if a request by the user to cancel the downloading is received while the title or application is reproduced during the downloading, invalidating the separately stored disc ID.

11. An apparatus for downloading and reproducing content related to a disc, the apparatus comprising:
a local storage manager arranged to download a content file related to the disc to be updated or added, via a network; and
an application manager arranged to store, if a request from a user to remove the disc is received during downloading, an identification (ID) of the disc to be removed, and continue the downloading,
wherein the disc ID is not updated until the downloading is completed regardless of whether a new disc is inserted.

12. The apparatus as claimed in claim 11, wherein, if the downloading is completed, the application manager updates the disc ID with an ID of a currently inserted disc.

13. The apparatus as claimed in claim 12, wherein, if a new disc is inserted during the downloading, the application manager controls the reproduction of a title recorded on the new disc according to a request from the user, while continuing the downloading.

14. The apparatus as claimed in claim 13, wherein, if a request from the user to cancel the downloading is received while the title is reproduced with continuing the downloading, the application manager invalidates the separately stored disc ID.

15. The apparatus as claimed in claim 12, wherein, if a new disc is inserted during the downloading, the application manager controls execution of an application recorded on the new disc by using the separately stored disc ID according to a request from the user, while continuing the downloading.

16. The apparatus as claimed in claim 15, wherein, if a request from the user to cancel the downloading is received while the application is executed with continuing the downloading, the application manager invalidates the separately stored disc ID.

17. A reproducing apparatus for downloading and reproducing content related to a disc, the apparatus comprising:
a first manager arranged to control the download of a content file related to the disc, via a network; and
a second manager arranged to store, if a request from a user to remove the disc is received during the downloading, an ID of the disc to be removed and, if the downloading is completed, update the disc ID with an ID of a currently inserted disc,
wherein the second manager maintains the disc ID without change until the downloading is completed, even though a new disc is inserted, and
wherein the first manager continues the downloading by using the disc ID, regardless of whether the disc is removed.

18. The apparatus as claimed in claim 17, wherein, if a new disc is inserted during the downloading, the second manager controls the downloading and at the same time, according to a request from the user, a title or application recorded on the new disc is reproduced.

19. The apparatus as claimed in claim 18, wherein the second manager controls so that the application is executed by using the separately stored disc ID.

20. The apparatus as claimed in claim 18, wherein, if a request by the user to cancel the downloading is received while the title or application is reproduced during the downloading, the second manager invalidates the separately stored disc ID.

21. An apparatus which reproduces a multimedia content recorded on an optical disc, comprising:
a reading unit to read a multimedia content recorded on an optical disc;
a local storage manager to download a multimedia content, via a network;
a manifest manager to bind the recorded content with the downloaded content; and
a reproducing unit to reproduce the recorded content together with the downloaded content,
wherein the reproducing unit is provided with an application manager to store an ID of the optical disc to be replaced, when the optical disc is being replaced during the downloading of the content, via the network, and to update the disc ID until the downloading is completed regardless of whether a new optical disc is inserted therein.

22. The apparatus as claimed in claim 21, wherein the application manager updates the disc ID with an ID of a currently inserted optical disc, when the downloading is completed.

23. The apparatus as claimed in claim 21, wherein, if a new optical disc is inserted during the downloading, the application manager controls the reproduction of a title recorded on the new optical disc according to a request from the user, while continuing the downloading.

24. The apparatus as claimed in claim 21, wherein the application manager invalidates the stored disc ID, upon receipt of a user request to cancel the downloading while the title is reproduced during the downloading.

25. The apparatus as claimed in claim 21, wherein, if a new disc is inserted during the downloading, the application manager controls execution of an application recorded on the new optical disc using the stored disc ID according to a request from the user, while continuing the downloading.
